(19) United States
(12) Patent Application Publication
(10) Pub. No.: US 2005/0147059 A1
(43) Pub. Date: Jul. 7, 2005

(54) Mobile terminal with down-link synchronisation via an iterative correlation system

(75) Inventor: Yanmeng Sun, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,278

(22) PCT Filed: Feb. 7, 2003
(86) PCT No.: PCT/IB03/00494

(30) Foreign Application Priority Data
Mar. 5, 2002 (EP) 02075847.0

(51) Int. Cl. H04B 7/212

(52) U.S. Cl. 370/324

(57) ABSTRACT

Mobile terminals (10) with down-link synchronization through detection of code signals used in Time Division—Synchronous Code Division Multiple Access (TD-SCDMA) telecommunication systems and/or in Universal Mobile Terrestrial System—Frequency Division Duplexing (UMTS-FDD) telecommunication systems detect these code signals by using a correlator system (1) for making sliding correlations, which require much processing capacity. By introducing a controller (3) for making iterative correlations in combination with an adaptable information compactness, the processing capacity can be reduced a lot. Preferably, comparator (4) compares correlation results with thresholds, with said controller (3) selecting smaller parts within said part of said input signal for a next correlation. By increasing the information compactness of said smaller parts, the accuracy of a next correlation is improved. A down-sampler (5) is used for controlling said information compactness, with a down-sampling factor being decreased for a next correlation to increase said information compactness for said next correlation.

The invention relates to a correlation system for correlating at least a part of an input signal with at least a part of at least one code signal.

The invention also relates to a mobile terminal with down-link synchronisation through detection of at least one code signal, which mobile terminal comprises a receiver for receiving a radio signal and for converting said radio signal into an input signal and comprises a correlation system coupled to said receiver for correlating at least a part of said input signal with at least a part of at least one code signal, and to a method for correlating at least a part of an input signal with at least a part of at least one code signal, and to a processor program product for correlating at least a part of an input signal with at least a part of at least one code signal, and to a method for down-link synchronisation through detection of at least one code signal, which method comprises the steps of receiving a radio signal and of converting said radio signal into an input signal and of correlating at least a part of said input signal with at least a part of at least one code signal.

Such a correlation system and such a mobile terminal are for example used in Time Division—Synchronous Code Division Multiple Access (TD-SCDMA) telecommunication systems and/or in Universal Mobile Terrestrial System—Frequency Division Duplexing (UMTS-FDD) telecommunication systems, in which a synchronisation code (code signal) is repeatedly sent in a down-link synchronisation channel to a mobile terminal. The mobile terminal must detect this synchronisation code rapidly and accurately without any prior knowledge, apart from the synchronisation code itself. Thereto, the mobile terminal comprises a correlation system having for example a matched filter for making sliding correlations. After several sliding correlations, the best correlation result (like for example the highest correlation peak) indicates the final result.

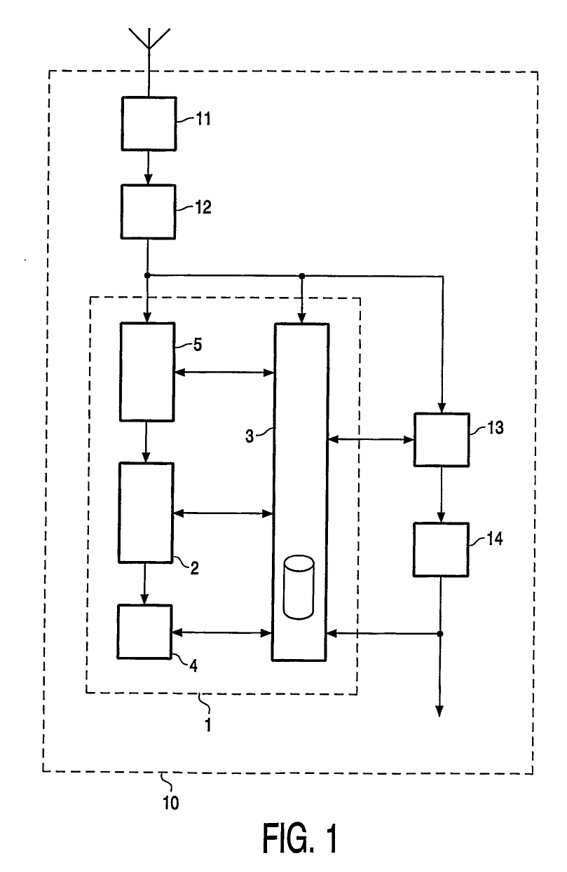

A prior art correlation system is known from U.S. Pat. No. 5,982,763. The receiver (unit 602 in FIG. 10 of U.S. Pat. No. 5,982,763) in the mobile terminal receives a radio signal originating from a base station and comprising the code signal, and converts said radio signal into the input signal. Then the correlation system (unit 102 in FIG. 1 of U.S. Pat. No. 5,982,763) coupled to said receiver correlates said input signal with one or more code signals which each have been previously stored in a terminal's memory. Thereto said correlation system comprises one or more correlators for making said sliding correlations.

The known correlation system is disadvantageous, inter alia, due to requiring too much processing capacity. Said code signal is repeatedly sent in the down-link channel, thereby using either each entire time-slot or just a part of each time-slot of this down-link channel, with the other part of each time-slot then for example being used for data Then per time-slot said sliding correlations must be performed, with each sliding correlation comprising the sliding (chip for chip) of the length of a code signal through a predefined part of said input signal. Such a computational complexity is extremely high, due to each sliding correlation per chip-sliding comprising one or more calculations.

It is an object of the invention, inter alia, of providing a correlation system as [symbol] efined in the preamble which requires less processing capacity.

The correlation system according to the invention is characterised in that said [symbol] rrelation system comprises a controller for controlling said correlation system for [symbol] erforming iterative correlations and for adapting at least an information compactness of at [symbol] ast a part of at least one of said signals for a next correlation.

By introducing iterative correlations, the results of previous correlations can [symbol] used for (improving) next correlations. And by introducing an adaptable information [symbol] mpactness (information density) of at least one of said signals, the processing capacity can [symbol] reduced a lot, under the condition that a result of a previous correlation can still be used [symbol] r (improving) a next correlation. This allows iterative correlations to be performed in an [symbol] timal way.

Said next correlation will generally but not exclusively be a subsequent [symbol] rrelation. So, it is not to be excluded that one or more further correlations are situated [symbol] etween a previous correlation and a next correlation.

The invention is based upon an insight, inter alia, that complicated correlations [symbol] n be replaced by less complicated iterative correlations, and is based upon a basic idea, [symbol] ter alia, that the complexity of a correlation can be amended by adapting the information [symbol] mpactness (information density).

The invention solves the problem, inter alia, of providing a correlation system [symbol] defined in the preamble which requires less processing capacity.

A first embodiment of the correlation system according to the invention as defined in claim 2 is advantageous in that said correlation system comprises a comparator for comparing a correlation result with at least one threshold and in response generating a comparison result, with said controller, in dependence of said comparison result, selecting smaller parts within said part of said input signal for a next correlation.

By, in dependence of said comparison result, selecting smaller parts, like for example four smaller parts each being about 10% of said part of said input signal and each comprising a correlation result (like for example a correlation peak) exceeding said threshold, a next correlation just uses 4×10%=40% of the original part for finding the best correlation result (like for example the highest correlation peak) with reduced processing capacity (being 40% of the original processing capacity).

A second embodiment of the correlation system according to the invention as defined in claim 3 is advantageous in that the information compactness of at least said smaller parts is increased for a next correlation.

By increasing the information compactness (information density) of said smaller parts, the accuracy of this next correlation is improved. In case of said information compactness (information density) of said four smaller parts being doubled, said next correlation still uses just 40% of the original part, with the reduced processing capacity still being lower than the original processing capacity (but now being 80% of the original processing capacity).

A third embodiment of the correlation system according to the invention as defined in claim 4 is advantageous in that said correlation system comprises a down-sampler for generating said input signal and coupled to an output of an analog-to-digital converter for, in dependence of said comparison result, down-sampling an output signal of said analog-to-digital converter with a down-sampling factor.

By introducing said down-sampler, like for example a memory for storing y samples and for reading out y/2 or y/4 etc. samples, or like for example a switch for letting pass every second or fourth etc. sample and for blocking all other samples, the information compactness (information density) can be controlled easily.

A fourth embodiment of the correlation system according to the invention as defined in claim 5 is advantageous in that said down-sampling factor is decreased for a next correlation to increase said information compactness for said next correlation.

By decreasing said down-sampling factor for next correlations, like for example from a factor eight via a factor four and a factor two to a factor one, said information compactness (information density) for these next correlations is increased. Said decreasing of said down-sampling factor corresponds with increasing a down-sampling rate/frequency, due to said down-sampling factor and said down-sampling rate/frequency being reciprocal. The minimum value of the down-sampling factor is one, which means that the maximum value of the down-sampling rate/frequency is equal to the full over-sampling rate/frequency. Together with said selection of said smaller parts, the iterative correlations are now performed in the most optimal way. Of course, after the down-sampling factor has reached its minimum value one, the down-sampling rate/frequency will be kept equal to this full over-sampling rate/frequency, with further selections of smaller parts still belonging to the possibilities and therefore not to be excluded.

For each one of said embodiments, said next correlation will generally but not exclusively be a subsequent correlation. So, it is not to be excluded that one or more further correlations are situated between a previous correlation and a next correlation.

Embodiments of the mobile terminal according to the invention, of the method for correlating according to the invention, of the processor program product according to the invention and of the method for down-link synchronisation according to the invention correspond with the embodiments of the correlation system according to the invention.

These and other aspects of the invention will be apparent from and elucidated with reference to the embodiments(s) described hereinafter.

FIG. 1 illustrates in block diagram form a mobile terminal according to the invention comprising a correlator system according to the invention, and

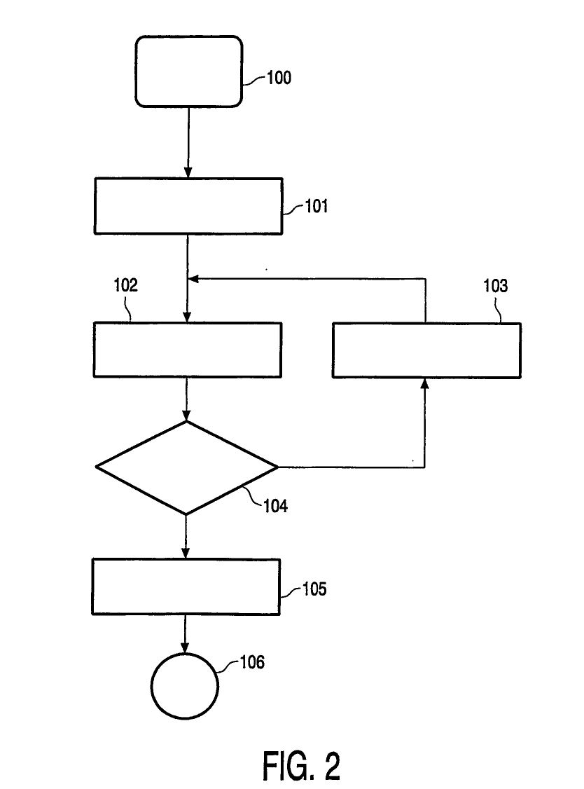

FIG. 2 illustrates a flow chart for elucidating a method according to the invention and a processor program product according to the invention.

FIG. 1 illustrates in block diagram form a mobile terminal 10 comprising a correlator system 1 according to the invention. Correlator system 1 comprises a controller 3 for controlling a down-sampler 5, a correlator 2 and a comparator 4. An input of down-sampler 5 forms an input of correlator system 1, and an output of down-sampler 5 is coupled to an input of correlator 2, of which an output is coupled to an input of comparator 4. Control in/outputs of controller 3 are coupled to control in/outputs of down-sampler 5, correlator 2 and comparator 4. A control input of controller 3 is coupled to the input of correlator system 1. A further control in/output of controller 3 is coupled to a control in/output of a decoder 13, of which an input is coupled to said input of correlator system 1 and of which an output is coupled to an input of a detector 14, of which an output for generating decoded/detected data is coupled to a further control input of controller 3. Correlator 2 for example comprises one or more matched filters.

Mobile terminal 10 further comprises, in addition to said correlator system 1, decoder 13 and detector 14, a receiver 11 of which an input is coupled to coupled to an antenna and of which an output is coupled to an input of an analog-to-digital converter 12, of which an output is coupled to said input of correlator system 1 and to the input of decoder 13.

According to prior art, the mobile terminal 10 with down-link synchronisation through detection of at least one code signal comprises a receiver 11 for receiving a radio signal and for converting said radio signal into an input signal and comprises a correlation system 1 coupled to said receiver 11 for correlating at least a part of said input signal with at least a part of at least one code signal.

Such a correlation system 1 and such a mobile terminal 10 are for example used in Time Division—Synchronous Code Division Multiple Access (TD-SCDMA) telecommunication systems and/or in Universal Mobile Terrestrial System—Frequency Division Duplexing (UMTS-FDD) telecommunication systems, in which a synchronisation code (code signal) is repeatedly sent in a down-link synchronisation channel to a mobile terminal 10. The mobile terminal 10 must detect this synchronisation code rapidly and accurately without any prior knowledge, apart from the synchronisation code itself. Thereto, the mobile terminal 10 comprises a correlation system 1 having for example a matched filter for making sliding correlations. After several sliding correlations, the best correlation result (like for example the highest correlation peak) indicates the final result.

A prior art correlation system 1 is known from U.S. Pat. No. 5,982,763. The receiver 11 (unit 602 in FIG. 10 of U.S. Pat. No. 5,982,763) in the mobile terminal 10 receives a radio signal originating from a base station and comprising the code signal, and converts said radio signal into the input signal. Then the correlation system 1 (unit 102 in FIG. 1 of U.S. Pat. No. 5,982,763) coupled to said receiver 11 correlates said input signal with one or more code signals which each have been previously stored in a terminal's memory for example forming part of controller 3. Thereto said correlation system 1 comprises one or more correlators 2 for making said sliding correlations.

The known correlation system 1 is disadvantageous, inter alia, due to requiring too much processing capacity. Said code signal is repeatedly sent in the down-link channel, thereby using either each entire time-slot or just a part of each time-slot of this down-link channel, with the other part of each time-slot then for example being used for data. Then per time-slot said sliding correlations must be performed, with each sliding correlation comprising the sliding (chip for chip) of the length of a code signal through a predefined part of said input signal. Such a computational complexity is extremely high, due to each sliding correlation per chip-sliding comprising one or more calculations.

It is an object of the invention, inter alia, of providing a correlation system 1 as defined before which requires less processing capacity.

The correlation system 1 according to the invention is characterised in that said correlation system 1 comprises a controller 3 for controlling said correlation system for performing iterative correlations and for adapting at least an information compactness of at least a part of at least one of said signals for a next correlation.

By introducing iterative correlations, the results of previous correlations can be used for (improving) next correlations. And by introducing an adaptable information compactness (information density) of at least one of said signals, the processing capacity can be reduced a lot, under the condition that a result of a previous correlation can still be used for (improving) a next correlation. This allows iterative correlations to be performed in an optimal way.

Said next correlation will generally but not exclusively be a subsequent correlation. So, it is not to be excluded that one or more further correlations are situated between a previous correlation and a next correlation.

A first embodiment of the correlation system 1 according to the invention is advantageous in that said correlation system 1 comprises a comparator 4 for comparing a correlation result with at least one threshold and in response generating a comparison result, with said controller 3, in dependence of said comparison result, selecting smaller parts within said part of said input signal for a next correlation.

By, in dependence of said comparison result, selecting smaller parts, like for example four smaller parts each being about 10% (or 1%) of said part of said input signal and each comprising a correlation result (like for example a correlation peak) exceeding said threshold, a next correlation just uses 4×10% (or 1%)=40% (or 4%) of the original part for finding the best correlation result (like for example the highest correlation peak) with reduced processing capacity (being 40% (or 4%) of the original processing capacity).

A second embodiment of the correlation system 1 according to the invention is advantageous in that the information compactness of at least said smaller parts is increased for a next correlation.

By increasing the information compactness (information density) of said smaller parts, the accuracy of this next correlation is improved. In case of said information compactness (information density) of said four smaller parts being doubled, said next correlation still uses just 40% (or 4%) of the original part, with the reduced processing capacity still being lower than the original processing capacity (but now being 80% (or 8%) of the original processing capacity).

A third embodiment of the correlation system 1 according to the invention is advantageous in that said correlation system 1 comprises a down-sampler 5 for generating said input signal and coupled to an output of an analog-to-digital converter 12 for, in dependence of said comparison result, down-sampling an output signal of said analog-to-digital converter 12 with a down-sampling factor.

By introducing said down-sampler 5, like for example a memory for storing y [symbol] nples and for reading out y/2 or y/4 or y/8 etc. samples, or like for example a switch for [symbol] ing pass every second or fourth or eighth etc. sample and for blocking all other samples, [symbol] information compactness (information density) can be controlled easily.

A fourth embodiment of the correlation system 1 according to the invention is [symbol] antageous in that said down-sampling factor is decreased for a next correlation to increase [symbol] d information compactness for said next correlation.

By decreasing said down-sampling factor for next correlations, like for [symbol] ample from a factor eight via a factor four and a factor two to a factor one, said [symbol] ormation compactness (information density) for these next correlations is increased. Said [symbol] creasing of said down-sampling factor corresponds with increasing a down-sampling [symbol] e/frequency, due to said down-sampling factor and said down-sampling rate/frequency [symbol] ing reciprocal. The minimum value of the down-sampling factor is one, which means that [symbol] e maximum value of the down-sampling rate/frequency is equal to the full over-sampling [symbol] e/frequency. Together with said selection of said smaller parts, the iterative correlations [symbol] e now performed in the most optimal way. Of course, after the down-sampling factor has [symbol] ached its minimum value one, the down-sampling rate/frequency will be kept equal to this [symbol] ll over-sampling rate/frequency, with further selections of smaller parts still belonging to [symbol] e possibilities and therefore not to be excluded.

For each one of said embodiments, said next correlation will generally but not exclusively be a subsequent correlation. So, it is not to be excluded that one or more further correlations are situated between a previous correlation and a next correlation.

The invention is based upon an insight, inter alia, that complicated correlations can be replaced by less complicated iterative correlations, and is based upon a basic idea, inter alia, that the complexity of a correlation can be amended by adapting the information compactness (information density).

The invention solves the problem, inter alia, of providing a correlation system as defined before which requires less processing capacity.

So, more practically, a radio signal arriving via said antenna is supplied to receiver 11 and converted into an analog input signal, which by analog-to-digital converter 12 is digitised into a digital input signal. These signals comprise a code signal like a synchronisation code, which is repeatedly transmitted and which must be detected for synchronisation purposes. To be able to make this detection, without any prior knowledge apart from the code signal itself, the digital input signal is correlated with said code signal through correlation system 1, with said code signal being stored in a terminal's memory for example forming part of controller 3. Analog-to-digital converter 12 for example over-samples the analog input signal with a frequency of for example four times the frequency corresponding with a chip period, for example to allow large noise-fluctuations and/or large phase-fluctuations in the radio signal to be dealt with. As a result, the digital input signal comprises four times more samples, which requires a large processing capacity when correlating such a received signal with a stored signal. This four times over-sampling rate/frequency is minimally necessary for down-link synchronisation in the UMTS-FDD system. By the end of the correlation procedure, the final sampling rate/frequency must be four times the frequency corresponding with a chip period (so when the down-sampling factor is equal to one), to meet system requirements. In the TD-SCDMA system, the final sampling rate/frequency must be minimally eight times the frequency corresponding with a chip period (so when the down-sampling factor is equal to one), to meet system requirements.

To reduce the processing capacity, between receiver 11 and analog-to-digital converter 12 on the one hand and correlator 2 on the other hand, down-sampler 5 has been introduced. Down-sampler 5 for example comprises a memory for, per predefined time-interval for example defining a predefined part of said digital input signal, storing y samples and for reading out y/4 or y/2 or y samples respectively, or comprises for example a switch for letting pass every fourth or second or each sample respectively and for blocking all other samples, to control the information compactness (information density) easily. For a first correlation, every fourth sample of all samples originating from and/or stored in analog-to-digital converter 12 is selected for making one or more sliding correlations via correlator 2. Thereby it should be noted that either every fourth sample of said code signal should be used or the other three out of four samples of the input signal should be defined to be equal to zero. Comparator 4, in addition to a comparison section further for example comprising a power measurement section and/or a power calculation section and/or an averaging section and/or a peak detection section, compares a first correlation result with one or more thresholds for example generated by controller 3, with a first comparison result being supplied to controller 3.

In response to this first comparison result, controller 3, comprising a selection section, selects smaller parts within said predefined part, with said smaller parts for example to be called windows. For example four windows each comprising a peak exceeding said one or more thresholds are selected, with each window for example being 10% or 1% of the predefined part. Controller 3 informs correlator 2 of these windows to be used for a second correlation, and further comprises an adapting section for adapting the information compactness (information density) such that for said second correlation, every second sample of all samples originating from and/or stored in analog-to-digital converter 12 is selected for making one or more sliding correlations via correlator 2, but now just for said four windows. Controller 3 informs down-sampler 5, said second correlation comprising one or more sliding correlations is made, and comparator 4 compares a second correlation result with one or more thresholds for example generated by controller 3, with a second comparison result being supplied to controller 3.

In response to this second comparison result, controller 3 selects either yet smaller parts within said smaller parts (windows) or selects a few (for example two out of four) of said smaller parts (windows) to be used for a third correlation. For example four windows each comprising a peak exceeding said one or more thresholds are selected, with each window for example being 1% or 0.1% of the predefined part, or two out of four windows are selected. Controller 3 informs correlator 2 of these recently defined new windows to be used for a third correlation, and further adapts the information compactness (information density) such that for said third correlation, every sample of all samples originating from and/or stored in analog-to-digital converter 12 is selected for making one or more sliding correlations via correlator 2, but now just for said recently defined windows. Controller 3 informs down-sampler 5, said third correlation comprising one or more sliding correlations is made, and comparator 4 compares a third correlation result with one or more thresholds for example generated by controller 3, with a third comparison result being supplied to controller 3. For example at the hand of this third comparison result, the final result is chosen, as a result of which mobile terminal 10 is synchronised with the base station.

Then, for example in case of the mobile terminal 10 needing to identify the cell in which it is located, spreading codes are sent from base station to mobile terminal 10, which are detected through correlator 2 again by making sliding correlations, thereby using or not using down-sampler 5. As soon as said spreading codes have been identified, controller 3 supplies these codes to decoder 13 for example comprising a despreader section, after which detector 14 for example comprising a pilot symbol assisted coherent detection section and/or a rake receiver section can generate (reconstruct) data transmitted from base station to mobile terminal 10.

Alternatively and/or in addition to using down-sampler 5, the information compactness (information density) of the input signal could be adapted by adapting the over-sample frequency used by analog-to-digital converter 12, and/or by placing (integrating) another down-sampler into analog-to-digital converter 12, which then need to be controlled by controller 3.

Usually the code signal in the radio signal and the input signal is repeatedly transmitted from base station to mobile terminal 10, but it is not to be excluded that, in other systems, such a code signal is sent only once, and then being stored in mobile terminal 10, for example in a buffer in receiver 11 and/or in analog-to-digital converter 12.

Each block shown or not shown, can be 100% hardware, 100% software or a mixture of both. Each block shown or not shown can be integrated with each other block shown and/or not shown. Especially correlation system 1 can be integrated advantageously due to comprising a lot of digital signal processing technology. Said receiver 11, analog-to-digital converter 12, decoder 13 and detector 14 may each comprise their own processor and/or memory, buffer etc. or may use (arts of) correlation system 1. And parts of correlation system 1 may comprise their own processor and/or memory, buffer etc.

In the flow chart shown in FIG. 2 for elucidating a method according to the invention and a processor program product according to the invention, the following blocks have the following meaning:
Block 100: Start; goto 101;
Block 101: Reduce the information compactness (information density) of at least a part of said input signal and/or of at least a part of said code signal, for example by introducing a down-sampling factor; goto 102;
Block 102: Correlate at least a part of said input signal with at least apart of said code signal for the given information compactness (information density) and for one or more given windows and compare one or more correlation results with one or more thresholds; goto 104;
Block 104: Is the information compactness (information density) standard, due to for example said down-sampling factor being equal to one? If yes, goto 105, if no, goto 103;
Block 103: Increase the information compactness (information density) of at least a part of said input signal and/or of at least a part of said code signal, for example by decreasing said down-sampling factor (or increasing the reciprocal down-sampling rate/frequency), and select windows within said part of said input signal in dependence of one or more comparison results; goto 102;
Block 105: Choose the best comparison result as the final result, the mobile terminal is now synchronised; goto 106;
Block 106: Stop.

The method according to the invention for correlating at least a part of an input signal with at least a part of at least one code signal is characterised in that said method comprises the step of controlling said correlating for performing iterative correlations and for adapting at least an information compactness of at least a part of at least one of said signals for a next correlation. And the processor program product according to the invention for correlating at least a part of an input signal with at least a part of at least one code signal, characterised in that said processor program product comprises the function of controlling said correlating for performing iterative correlations and for adapting at least an information compactness of at least a part of at least one of said signals for a next correlation. Said steps and functions are for example as follows:

A first step/function comprises the starting of said method/processor program product (Block 100). Then, a second step/function involves the reducing of the information compactness (information density) of at least a part of said input signal and/or of at least a part of said code signal, for example by introducing a down-sampling factor (Block 101). A third step/function comprises the correlating of at least a part of said input signal with at least a part of said code signal for the given information compactness (information density) and for one or more given windows and the comparing of one or more correlation results with one or more thresholds (Block 102). A fourth step/function involves the checking whether the [symbol] rmation compactness (information density) is standard or not, due to for example said [symbol] vn-sampling factor being equal to one or not (Block 104). If no, a fourth step/function [symbol] oprises the increasing of the information compactness (information density) of at least a [symbol] t of said input signal and/or of at least a part of said code signal, for example by [symbol] reasing said down-sampling factor (or increasing the reciprocal down-sampling [symbol] /frequency), and the selecting of windows within said part of said input signal in [symbol] endence of one or more comparison results (Block 103), which is followed by said third [symbol] /function, but now with updated information, etc. If yes, a next step/function involves the [symbol] osing of the best comparison result as the final result, the mobile terminal is now [symbol] chronised (13lock 105). Then, a following final step/function comprises the ending of said [symbol] thod/processor program product (Block 107).

Of course, further steps/functions are not to be excluded, like for example a [symbol] mting step/function for counting the number of loops made to avoid the infinite looping, [symbol] l like for example a comparing step/function for comparing comparison results with each for finding out howmuch progress is made, and like for example an updating action for updating thresholds, etc.

1. Correlation system (1) for correlating at least a part of an input signal with at least a part of at least one code signal, characterised in that said correlation system (1) comprises a controller (3) for controlling said correlation system (1) for performing iterative correlations and for adapting at least an information compactness of at least a part of at least one of said signals for a next correlation.

2. Correlation system (1) according to claim 1, characterised in that said correlation system (1) comprises a comparator (4) for comparing a correlation result with at least one threshold and in response generating a comparison result, with said controller (3), in dependence of said comparison result, selecting smaller parts within said part of said input signal for a next correlation.

3. Correlation system (1) according to claim 2, characterised in that the information compactness of at least said smaller parts is increased for a next correlation.

4. Correlation system (1) according to claim 3, characterised in that said correlation system (1) comprises a down-sampler (5) for generating said input signal and coupled to an output of an analog-to-digital converter (12) for, in dependence of said comparison result, down-sampling an output signal of said analog-to-digital converter (12) with a down-sampling factor.

5. Correlation system (1) according to claim 4, characterised in that said down-sampling factor is decreased for a next correlation to increase said information compactness for said next correlation.

6. Mobile terminal (10) with down-link synchronisation through detection of at least one code signal, which mobile terminal (10) comprises a receiver (11) for receiving a radio signal and for converting said radio signal into an input signal and comprises a correlation system (1) coupled to said receiver (11) for correlating at least a part of said input signal with at least a part of at least one code signal, characterised in that said correlation system (1) comprises a controller (3) for controlling said correlation system (1) for performing iterative correlations and for adapting at least an information compactness of at least a part of at least one of said signals for a next correlation.

7. Mobile terminal (10) according to claim 6, characterised in that said correlation system (1) comprises a comparator (4) for comparing a correlation result with at least one threshold and in response generating a comparison result, with said controller (3), in dependence of said comparison result, selecting smaller parts within said part of said input signal for a next correlation.

8. Mobile terminal (10) according to claim 7, characterised in that the information compactness of at least said smaller parts is increased for a next correlation.

9. Mobile terminal (10) according to claim 8, characterised in that said correlation system (1) comprises a down-sampler (5) for generating said input signal and coupled to an output of an analog-to-digital converter (12) for, in dependence of said comparison result, down-sampling an output signal of said analog-to-digital converter (12) with a down-sampling factor.

10. Mobile terminal (10) according to claim 9, characterised in that said down-sampling factor is decreased for a next correlation to increase said information compactness for said next correlation.

11. Method for correlating at least a part of an input signal with at least a part of at least one code signal, characterised in that said method comprises the step of controlling said correlating for performing iterative correlations and for adapting at least an information compactness of at least a part of at least one of said signals for a next correlation.

12. Processor program product for correlating at least a part of an input signal with at least a part of at least one code signal, characterised in that said processor program product comprises the function of controlling said correlating for performing iterative correlations and for adapting at least an information compactness of at least a part of at least one of said signals for a next correlation.

13. Method for down-link synchronisation through detection of at least one code signal, which method comprises the steps of receiving a radio signal and of converting said radio signal into an input signal and of correlating at least a part of said input signal with at least a part of at least one code signal, characterised in that said method comprises the step of controlling said correlating for performing iterative correlations and for adapting at least an information compactness of at least a part of at least one of said signals for a next correlation.
